(19) United States
(12) Patent Application Publication
(10) Pub. No.: US 2012/0215990 A1
(43) Pub. Date: Aug. 23, 2012

(54) METHOD AND APPARATUS FOR SELECTING A NODE WHERE A SHARED MEMORY IS LOCATED IN A MULTI-NODE COMPUTING SYSTEM

(75) Inventors: Jun Li, Hangzhou (CN); Xiaofeng Zhang, Hangzhou (CN)

(73) Assignee: Huawei Technologies Co., Ltd., Shenzhen (CN)

(21) Appl. No.: 13/340,193

(22) Filed: Dec. 29, 2011

Related U.S. Application Data
(63) Continuation of application No. PCT/CN2011/079464, filed on Sep. 8, 2011.

(30) Foreign Application Priority Data
Feb. 21, 2011 (CN) 201110041474.7

(51) Int. Cl. G06F 12/00

(52) U.S. Cl. 711/147; 711/E12.001

(57) ABSTRACT

A method and an apparatus for selecting a node where a shared memory is located in a multi-node computing system are provided, improving the total access performance of the multi-node computing system. The method comprises: acquiring parameters for determining a sum of memory affinity weight values between each of the CPUs and a memory on a random one of nodes; calculating the sum of the memory affinity weight values between each of the CPUs and the memory on the random one of the nodes according to the parameters; and selecting the node with the calculated minimal sum of the memory affinity weight values as the node where the shared memory for each of the CPUs is located.

### CROSS-REFERENCE TO RELATED APPLICATIONS

This application is a continuation of International Application No. PCT/CN2011/079464, filed on Sep. 8, 2011,which claims priority to Chinese Patent Application No. 201110041474.7, filed with the Chinese Patent on Feb. 21, 2011, which is hereby incorporated by reference in its entirety.

FIELD OF THE APPLICATION

The embodiments of the present application relate to the field of communication, and in particular to a method and apparatus for selecting a node where a shared memory is located in a multi-node computing system.

### BACKGROUND OF THE APPLICATION

As the continuous development of computing and storing technologies, a computing system where multiple nodes coexist (referred to as “a multi-node computing system”) is more and more popular. In order to overcome the bottleneck of a central processing unit (CPU) in the multi-node computing system in accessing a memory, non-uniform memory access (NUMA) architecture exists in the multi-node computing system. In the NUMA architecture, each of the applications may be operated on a certain hardware node. The CPU of such a node may access the memory regions on this node itself and other nodes. However, the access speeds and efficiencies on different nodes are different, since the CPU on each of the nodes has different “memory affinity” with respect to memories on different nodes. The so-called memory affinity refers to the delay in accessing, by each CPU, the memory on the node where the CPU is located or the memories on other nodes in an NUMA architecture, and the smaller the delay is, the higher the memory affinity is.

The affinity for a pair of CPU and memory is taken into consideration in an NUMA architecture in the prior art, that is, the connecting speed and hops of a bus between the CPU and a memory (the memory is not shared with the CPUs on other nodes) are acquired, and then [cpu, memory, val] is calculated by using the connecting speed and hops of the bus. “Cpu, memory” denotes a pair of CPU and memory (referred to as “CPU and memory pair”), val refers to a value of the affinity for the CPU and the memory, referred to as “memory affinity weight value”, and [cpu, memory, val] denotes that the memory affinity weight value for the CPU and memory pair constituted by the cpu and the memory is val. Different [cpu, memory, val] forms the CPU and memory pair affinity table. When an application needs to apply for a memory, the CPU and memory pair affinity table is inquired first to obtain a node with the highest memory affinity, and then a memory space is allocated on the node.

The above NUMA architecture provided in the prior art only solves the problem of memory affinity in case of without a shared memory. However, the existing NUMA architecture provides no solutions for how to select a most suitable node from multiple nodes as the node for allocating a shared memory when multiple CPUs need to share a memory, so as to optimize the total memory access efficiency such that the memory affinity is the highest when multiple nodes access the shared memory in the NUMA architecture

### SUMMARY OF THE APPLICATION

The embodiments of the present application provide a method and apparatus for selecting a node where a shared memory is located in a multi-node computing system, so as to allocate the shared memory to the optimal node, thereby improving the total access performance of a multi-node computing system.

The embodiment of the present application provides a method for selecting a node where a shared memory is located in a multi-node computing system. The method comprises: acquiring parameters for determining the sum of memory affinity weight values between each of the CPUs and a memory on a random node;

calculating a sum of the memory affinity weight values between each of the CPUs and the memory on the random one of the nodes, according to the parameters; and

selecting a node with the calculated minimal sum of the memory affinity weight values as the node where a shared memory for each of the CPUs is located.

The embodiment of the present application provides an apparatus for selecting a node where a shared memory is located in a multi-node computing system. The apparatus comprises:

a parameter acquiring module, for acquiring parameters for determining a sum of memory affinity weight values memory affinity weight values between each of the CPUs and a memory on a random one of the nodes;

a summing module, for calculating the sum of the memory affinity weight values between each of the CPUs and the memory on the random one of the nodes according to the parameters; and

a node selecting module, for selecting a node with the calculated minimal sum of the memory affinity weight values as the node where a shared memory for each of the CPUs is located.

It can be seen from the above embodiments of the present application that the method provided by the present application not only takes the case into consideration where multiple CPUs in a multi-node computing system need to share a memory, but also calculates out a node on which the sum of the memory affinity weight values is minimal according to the parameters for determining the sum of memory affinity weight values between each of the CPUs and a memory on a random node, and selects this node as the node where a shared memory is located. Since the sum of the memory affinity weight values between each of the CPUs accessing the shared memory and the memory on this node is minimal, the CPU on each of the nodes accesses the shared memory on this node at a minimal cost, and the access efficiency of the system in case of needing to access a shared memory is the highest, thereby improving the total access performance of the system.

### BRIEF DESCRIPTION OF THE DRAWINGS

Following is a brief introduction to the drawings used in the description of the prior art or the embodiments, so as to explain the technical solutions of the embodiments of the present application more clear. Obviously, the drawings described belong are merely some examples of the present application, and to those skilled in the art, other drawings may be obtained according to these drawings.

FIG. 1 is a flowchart of the method for selecting a node where a shared memory is located in a multi-node computing system according to an embodiment of the present application;

FIG. 2 is a structure schematic diagram of the apparatus for selecting a node where a shared memory is located in a multi-node computing system according to an embodiment of the present application;

FIG. 3 is a structure schematic diagram of the apparatus for selecting a node where a shared memory is located in a multi-node computing system according to another embodiment of the present application;

FIG. 4 is a structure schematic diagram of the apparatus for selecting a node where a shared memory is located in a multi-node computing system according to another embodiment of the present application;

FIG. 5 is a structure schematic diagram of the apparatus for selecting a node where a shared memory is located in a multi-node computing system according to another embodiment of the present application; and

FIG. 6 is a structure schematic diagram of the apparatus for selecting a node where a shared memory is located in a multi-node computing system according to another embodiment of the present application.

### DETAILED DESCRIPTION OF THE EMBODIMENTS

The embodiments of the present application provide a method and apparatus for selecting a node where a shared memory is located in a multi-node computing system, so as to allocate the shared memory to the optimal node, thereby improving the total access performance of the multi-node computing system.

The method for selecting a node where a shared memory is located in a multi-node computing system according to the embodiments of the present application will be described below by taking the multi-node computing system of an NUMA architecture as an example. It should be understood by those skilled in the art that the method according to the embodiments of the present application is not only applicable to a multi-node computing system of an NUMA architecture, but also to the cases when multiple nodes share a memory.

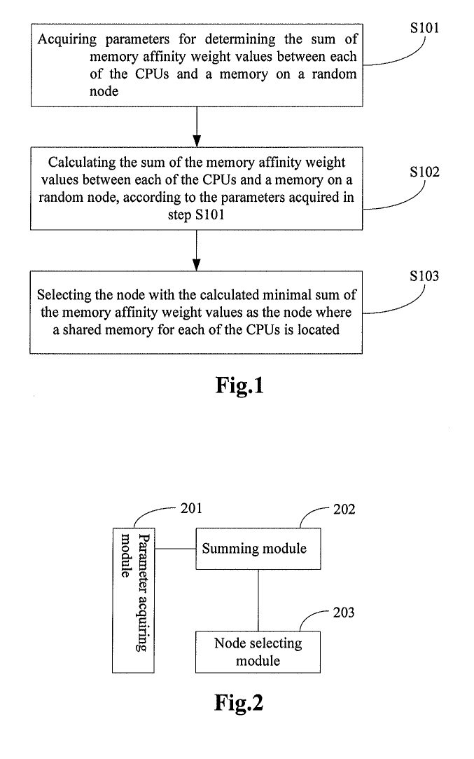

Referring to FIG. 1, which is a flowchart of the method for selecting a node where a shared memory is located in a multi-node computing system according to an embodiment of the present application.

In step S101, parameters for determining the sum of memory affinity weight values between each of the CPUs and a memory on a random node are acquired.

In the embodiment of the application, the parameters for determining the sum of memory affinity weight values between each of the CPUs and a memory on a random node comprise the memory node pair weight values for the node pairs where each of the CPUs is located, and the frequencies of accessing the memory on the random node by the each of the CPUs. Each of the CPUs may be a CPU on a certain node in a multi-node computing system in an NUMA architecture, and for some reason, these CPUs need to access the data on a certain node, i.e. access the shared memory on this node. It should be noted that a CPU accessing a shared memory may also be considered as accessing a certain shared memory by using CPU resources. For example, accessing a certain shared memory by operating an application at a certain node is accessing a certain shared memory by using the CPU resources on the application node. Another example, if a plurality of processes or a plurality of parts of a process need to access a certain shared memory, and different processes or different parts of a process may operate on different nodes, and when these processes start and begin to access the shared memory, the CUP resources on the nodes of the different processes or different parts of a process are used to access the shared memory.

In step S102, the sum of memory affinity weight values between each of the CPUs and a memory on a random node are calculated according to the parameters acquired in step S101.

In the embodiment of the application, the concept of the memory affinity weight value is substantially the same as that of the prior art, and both of which refer to the memory affinity weight value for a CPU and memory pair. For example, if each of the CPUs accessing a shared memory is denoted as cpu₁, cpu₂, . . . , cpuₘ, then the memory affinity weight value between each of the CPUs accessing a shared memory and a memory on a random node may be accordingly denoted as [cpu₁, memory₁, val₁], [cpu₂, memory₂, val₂], . . . , [cpuₘ, memoryₘ, valₘ]. The difference is that according to the embodiment of the present application the m CPUs, i.e. cpu₁, cpu₂, . . . and cpuₘ, need to access the shared memory, while no shared memory is taken into consideration in the prior art, that is, the m CPUs, i.e. cpu₁, cpu₂, . . . and cpuₘ, access the memories they need to access respectively, not a shared memory.

Assuming that in a multi-node computing system consisting of three nodes, Node₀, Node₁ and Node₂, the memory node pair weight values of the node pairs (Node₀, Node₀), (Node₁, Node₀) and (Node₀, Node₂) where the CPUs, CPU₀, CPU₁ and CPU₂, are located, are 0, 10 and 20, respectively, and the frequencies of accessing the memory on the node Node₀ by the CPU₀, CPU₁ and CPU₂ on Node₀, Node₁ and Node₂ are 50%, 40% and 10%, respectively, then the product of the memory node pair weight value of the node pair where each of the CPUs is located and the frequency of accessing the memory on the node by each of the CPUs is calculated as 0×50%, 10×40% and 20×10%, and the sum (denoted by Sum) of these products is Sum=0+4+2=6. Assuming that the memory node pair weight values of the node pairs (Node₀, Node₁), (Node₁, Node₁) and (Node₂, Node₁) where CPU₀, CPU₁ and CPU₂ are located, are 10, 0 and 10, respectively, and the frequencies of accessing the memory on the node Node₁ by CPU₀, CPU₁ and CPU₂ on Node₀, Node₁ and Node₂ are 30%, 50% and 20%, respectively, then the product of the memory node pair weight value of the node pair where each of the CPUs is located and the frequency of accessing the memory on the node by each of the CPUs is calculated as 10×30%, 0×50% and 10×20%, and the sum of these products is Sum=3+0+2=5. And assuming that the memory node pair weight values of the node pairs (Node₀, Node₂), (Node₁, Node₂) and (Node₂, Node₂) where CPU₀, CPU₁ and CPU₂ are located are 20, 10 and 0, respectively, and the frequency of accessing the memory on the node Node₂ by CPU₀, CPU₁ and CPU₂ on Node₀, Node₁ and Node₂ are 20%, 30% and 50%, respectively, then the product of the memory node pair weight values of the node pairs where each of the CPUs is located and the frequency of accessing the memory on the node by each of the CPUs is calculated as 20×20%, 10×30% and 0×50%, and the sum of these products is Sum=4+3+0=7.

In step S103, the node with the minimum calculated sum of the memory affinity weight values is selected as the node where a shared memory for each of the CPUs is located.

In the examples of step S102, the sum of the memory affinity weight values between CPU₀, CPU₁ and CPU₂ and the memory on Node₀ is 6, the sum of the memory affinity weight values between CPU₀, CPU₁ and CPU₂ and the memory on Node₁ is 5, and the sum of the memory affinity weight values between CPU₀, CPU₁ and CPU₂ and the memory on Node₂ is 7. Obviously the sum of the memory affinity weight values between CPU₀, CPU₁ and CPU₂ and the memory on Node₁ is minimal, and accordingly Node₁ is selected as the node where the shared memory is located.

It can be seen from the above embodiment, the method provided by the present application not only takes the case into consideration where multiple CPUs in a multi-node computing system need to share a memory, but also calculates out a node at which the sum of the memory affinity weight values is minimal according to the parameters for determining the sum of the memory affinity weight values between each of the CPUs and a memory on a random node, and selects this node as the node where a shared memory is located. Since the sum of the memory affinity weight values between each of the CPUs accessing the shared memory and the memory on this node is minimal, the CPU on each of the nodes accesses the shared memory on this node at a minimal cost, and the access efficiency of the system in case of needing to access a shared memory is the highest, thereby improving the total access performance of the system.

As described above, one of the parameters for determining the sum of memory affinity weight values between each of the CPUs and a memory on a random node is the memory node pair weight value of the node pair where each of the CPUs is located. The so-called memory node pair weight value of each node pair is the memory affinity weight value between the CPU on one node of the node pair and the memory on the other node of the node pair. For example, assuming that Node₁₁ where cpu₁ is located and Node₁₂ where memory₁ is located are a node pair (denoted by (Node₁₁, Node₁₂)), the memory node pair weight value of this node pair is denoted as [cpu₁, memory₁, val₁], wherein, val₁ is the memory affinity weight value between cpu₁ on Node₁₁ and Node₁₂. Particularly, in comparison of Node₁₁ where cpu₁ is located and other nodes (such as Node₁₂ in the above embodiment), the weighted value of memory affinity between cpu₁ on Node₁₁ and the memory on Node₁₁ is minimal, which may be considered as being 0, denoting a reference value.

In specific implementations, a storage region may be maintained in each of the nodes in a multi-node computing system. An access delay value for the CPU of the node where the storage region is located to access a memory on a neighboring node of the node is stored. Furthermore, the access delay value may be converted into a memory affinity weight value through quantitative means to facilitate computing and storing. For example, if the access delay values for the CPU on the node Node₁ to access the memories on neighboring nodes Node₂, Node₄ and Node₆ of Node₁ are 0.3, 0.5 and 0.9, respectively, 0.3, 0.5 and 0.9 may be multiplied by 10, such that they may be converted into memory affinity weight values expressed by integers 3, 5 and 8, to facilitate computing and storing.

The memory affinity weight value between a CPU on some node and a memory on a non-neighboring node of this node may be acquired according to the memory affinity weight value between the CPU on this node and the memory on a neighboring node of this node. For example, if the memory affinity weight value between the CPU on Node₁ and the memory on a neighboring node Node₂ of this node is 3, the memory affinity weight value between the CPU on Node₂ and the memory on a neighboring node Node₃ of Node₂ is 5, and Node₃ is a non-neighboring node of Node₁, then the memory affinity weight value between the CPU on Node₁ and the memory on Node₃ may be the sum of the memory affinity weight value 3 between the CPU on Node₁ and the memory on its neighboring node Node₂ and the memory affinity weight value 5 between the CPU on Node₂ and the memory on the neighboring node Node₃ of Node₂, that is, 3+5=8.

After t he memory affinity weight value between the CPU on each node and a memory on a random node is calculated, a memory affinity weight value table may be formed as shown below.

TABLE 1

| | Node 0 | Node 1 | Node 2 | | Node n |
|---|---|---|---|---|---|
| Nodes | (Node0) | (Node1) | (Node2) | . . . | (Noden) |
| Node 0 | 0 | 10 | 20 | . . . | 100 |
| (Node0) | | | | | |
| Node 1 | 10 | 0 | 10 | . . . | 90 |
| (Node1) | | | | | |
| Node 2 | 20 | 10 | 0 | . . . | 80 |
| (Node2) | | | | | |
| . . . | . . . | . . . | . . . | . . . | . . . |
| Node n | 100 | 90 | 80 | . . . | 0 |
| (Noden) | | | | | |

In Table 1, the values at the crossings of rows and columns denote memory affinity weight values between the CPUs on the nodes of the corresponding row and the memories on the nodes of the corresponding column, or the CPUs on the nodes of the corresponding column and the memories on the nodes of the corresponding row. For example, the value 10 at the crossing of Row 2 and Column 3 in Table 1 denotes the memory affinity weight value between the CPU on Node 1 and the memory on Node 0 or between the CPU on Node 0 and the memory on Node 1. Particularly, the value 0 at the crossings of rows and columns in Table 1 denotes the memory affinity weight value between a CPU on a node and the memory on this node. For example, the value 0 at the crossing of Row 3 and Column 3 in Table 1 denotes that the memory affinity weight value between the CPU on Node 1 and the memory on Node 1 is 0. As described above, the memory affinity weight value 0 denotes a reference value.

It is not sufficient, in determining the sum of the memory affinity weight values between each CPU and the memory on which node is minimal, to take the memory node pair weight values of node pairs where each of the CPUs is located as the parameter for determining the sum of the memory affinity weight values between each CPU accessing the shared memory and the memory on a random node, since although the memory node pair weight value of the node pair where a certain CPU is located is relatively small, the CPU on this node frequently accesses the memory on the other node of the node pair, possibly causing that the sum of the memory affinity weight values between each CPU and the memory on the other node of the node pair is relatively large; on the contrary, although the memory node pair weight value of the node pair where a certain CPU is located is relatively large, the CPU on this node does not frequently access the memory on the other node of the node pair, possibly leading to that the sum of the memory affinity weight values between each CPU and the memory on the other node of the node pair is relatively small.

Base upon the fact described above, as another embodiment of the present application, the frequency of accessing a memory on a random node by each of the CPUs in a multi-node computing system may be taken as another parameter for determining the sum of the memory affinity weight values between each of the CPUs accessing the shared memory and the memory on the random node.

According to an embodiment of the present application, the number of times the CPU on one node of each node pair accesses the memory on a random node may be counted and the number of times are summed up, and then the ratio of the number of times to the sum of the number of times is obtained according to the number of times and the sum of the number of times The ratio is the frequency of accessing the memory on the random node by each of the CPUs. For example, if the number of times the CPU on node Node11 of node pair (Node11, Node12) accesses the memory on node Nodek is 30, the number of times the CPU on node Node21 of node pair (Node21, Node22) accesses the memory on node Nodek is 25, and the number of times the CPU on node Node31 of node pair (Node31, Node32) accesses the memory on node Nodek by is 45, then the ratio 30/(30+25+45)=30% is the frequency of accessing the memory on node Nodek by the CPU on node Node11, the ratio 25/(30+25+45)=25% is the frequency of accessing the memory on node Nodek by the CPU on node Node21, and the ratio 45/(30+25+45)=45% is the frequency of accessing the memory on node Nodek by the CPU on node Node31.

After the two parameters in the above embodiment are determined, the sum of memory affinity weigh values between each of the CPUs accessing the shared memory and the memory on a random node may be calculated according to the two parameters, and the method comprises the following steps.

The products of the memory node pair weigh values of the node pairs where each of the CPUs are located respectively and the frequencies of accessing the memory on a random node by each CPU are calculated first, and then these products are summed up. The sum of the products is the sum of the memory affinity weight values between each of the CPUs accessing the shared memory and the memory on the random node calculated according to the parameters.

For example, assuming in a multi-node computing system consisting of three nodes, Node₀, Node1 and Node2, the memory node pair weight values of the node pairs (Node0, Node0), (Node1, Node0) and (Node0, Node2) where CPUs CPU0, CPU1 and CPU2 are located, respectively, can be known from Table 1, which are listed in Table 2 below.

TABLE 2

| Nodes | Node0 (CPU0) | Node1 (CPU1) | Node2 (CPU2) |
|---|---|---|---|
| Node0 (memory0) | 0 | 10 | 20 |

The memory node pair weight values of the node pairs (Node0, Node1), (Node1, Node1) and (Node2, Node1) where CPUs CPU0, CPU1 and CPU2 are located, respectively, are listed in Table 3 below.

TABLE 3

| Nodes | Node0 (CPU0) | Node1 (CPU1) | Node2 (CPU2) |
|---|---|---|---|
| Node1 (memory1) | 10 | 0 | 10 |

And the memory node pair weight values of the node pairs (Node0, Node2), (Node1, Node2) and (Node2, Node2) where CPUs CPU0, CPU1 and CPU2 are located, respectively, are listed in Table 4 below.

TABLE 4

| Nodes | Node0 (CPU0) | Node1 (CPU1) | Node2 (CPU2) |
|---|---|---|---|
| Node2 (memory2) | 20 | 10 | 0 |

Furthermore, assuming that the frequencies of accessing the memory on Node0 by the CPUs CPU0, CPU1 and CPU2 on Node0, Node1 and Node2 are 50%, 40% and 10%, respectively, according to Table 2, the products of the memory node pair weight values of the node pairs where each of the CPUs are located and the frequencies of accessing the memory on the node by each of the CPUs are calculated as 0×50%, 10×40% and 20×10%, respectively, and the sum (denoted by Sum) of these products is Sum=0+4+2=6.

Assuming that the frequencies of accessing the memory on Node1 by the CPUs CPU0, CPU1 and CPU2 on Node0, Node1 and Node2 are 30%, 50% and 20%, respectively, according to Table 3, the products of the memory node pair weight values of the node pairs where each of the CPUs are located and the frequencies of accessing the memory on the node by each of the CPUs are calculated as 10×30%, 0×50% an 10×20%, respectively, and the sum of these products is Sum=3+0+2=5.

Assuming that the frequencies of accessing the memory on Node2 by the CPUs CPU0, CPU1 and CPU2 on Node0, Node1 and Node2 are 20%, 30% and 50%, respectively, according to Table 4, the products of the memory node pair weight values of the node pairs where each of the CPUs are located and the frequencies of accessing the memory on the node by each of the CPUs are calculated as 20×20%, 10×30% and 0×50%, respectively, and the sum of these products is Sum=4+3+0=7.

If the nodes accessed by CPUs CPU0, CPU1 and CPU2 are shown in first row, and the sums described above are shown in second row, the following may be obtained as listed in Table 5.

TABLE 5

| | Accessed nodes | | |
|---|---|---|---|
| | Node0 (memory0) | Node1 (memory 1) | Node2 (memory2) |
| Sum | 6 | 5 | 7 |

It can be seen from Table 5 that the sum of the memory affinity weight values between CPUs CPU0, CPU1 and CPU2 and the memory on node Node0 is 6, the sum of the memory affinity weight values between CPUs CPU0, CPU1 and CPU2 and the memory on node Node1 is 5, and the sum of the memory affinity weight values between CPUs CPU0, CPU1 and CPU2 and the memory on node Node2 is 7. Obviously the sum of the memory affinity weight values between CPUs CPU0, CPU1 and CPU2 and the memory on node Node1 is minimal. Hence, node Node1 is selected as the node where the shared memory is located. Through such a selection the CPUs CPU0, CPU1 and CPU2 on Node0, Node1 and Node2 of the multi-node computing system consisting of three nodes Node0, Node1 and Node2, access the shared memory node Node1 at a minimal cost with the highest efficiency, thereby improving the total access performance of the system.

According to the embodiment of the present application, after the node where the shared memory is located is selected, whether the memory on the node where the shared memory is located satisfies the access by each of the CPUs may also be checked. If it does not satisfy, for example, the capacity of the memory on the node where the shared memory is located is not enough or is exhausted, or, although the frequencies of accessing the memory on the node where the shared memory is located by the CPUs on each of the nodes in the multi-node computing system are known, deviations exist in the known access frequencies with respect to the actual access frequencies due to some reason (such as the reduction of the actual access frequencies due to the existence of a high-speed cache), then the node where the shared memory is located should be reselected according to the method provided by the above embodiment.

For further description of the method provided by the embodiments of the present application, a scenario where a protocol stack shares with an application a memory on a certain node in a multi-node computing system with an NUMA architecture when network receives data packets is illustrated below.

It is known that the object of network optimization is to reduce the memory copy times. The existing zero copy technology has substantially realized that a protocol stack shares a memory with an application. However, the delay produced in accessing a shared memory on a node in an NUMA architecture may possibly counteract the advantages of the zero copy technology. Such a defect may be overcome by the method for selecting a node where a shared memory is located in a multi-node computing system according to the embodiments of the present application. The specific implementation is illustrated in the following steps.

In step S201, the memory node pair weight value of the node pair where an application and a kernel (including a network protocol stack) are located is obtained.

Specifically, it may be obtained from the memory affinity weight value table stored in the system as illustrated in Table 1.

In step S202, the frequencies of accessing the memory on a random node by the application and the kernel are determined.

In step S203, the sum of the memory affinity weight values between the application and kernel and the memory on the random node is calculated from the memory node pair weight value acquired in step S201 and the frequencies of accessing the memory on the random node by the application and kernel determined in step S202 according to the method provided by the above embodiment.

After comparison, the node with the minimal sum of the memory affinity weight values is selected as the node where a shared memory is located. That is, when the network receives data packets, the data packets are transmitted to the node for storage, so as to be shared by each node in the multi-node computing system of an NUMA architecture;

In step S204, the address of the node where the shared memory is located is transmitted to the network interface card of the native computer as a transmission address of direct memory access (DMA).

Furthermore, the hardware queue provided by the network interface card is bound to the address of the node where the shared memory is located. When the data transmission is started, the data packet is configured with a suitable media access control (MAC) head.

In step S205, the data packets are queued according to the certain field at the head of the packet MAC, after the network interface card receives the data packets.

In step S206, the received data packets are transmitted to the shared memory in the DMA manner, according to the address of the node where the shared memory is located.

A CPU may also be informed, by interruption, of starting a polling operation.

In step S207, when the application is handed over to another node to operate due to some reason, the flow turns back to step S202.

For example, the application is handed over to another node to operate due to, that the capacity of the memory on the node where the shared memory is located is not enough or is exhausted, or deviations exist in the obtained access frequencies with respect to the actual access frequencies due to a high-speed cache, or the sum of the memory affinity weight values between the application and the memory on the random node is relatively large, etc.

In step S208, relevant resources are released after the transmission of the data packets is terminated.

The method provided by the embodiments of the present application may also be applicable to the case where a plurality of processes or a plurality of parts of a process need to access a certain shared memory and these processes or these parts of a process operate on different nodes. The implementation method is substantially similar to that a protocol stack and an application share a memory on a certain node in a multi-node computing system of an NUMA architecture when a network receives data packets. What is different is that different processes or every parts of the same process share a memory on a certain node, and the steps are as follows.

In step S301, memory node pair weight values of the node pairs where different processes or every parts of the same process are located are acquired.

In step S302, the frequencies of accessing the memory on a random node by the different processes or every parts of the same process are determined.

In step S303, the sum of the memory affinity weight values between the different processes or every parts of the same process and the memory on the random node is calculated from the memory node pair weight values acquired in step S301 and the frequencies of accessing the memory on the random node by the different processes or every parts of the same process determined in step S302 according to the method provided by the above embodiment.

In step S304, after comparison, the node with the minimal sum of the memory affinity weight values is selected as the node where a shared memory is located. That is, a memory region on the node is allocated as the shared memory for the different processes or every parts of the same process.

It should be noted that although an application scenario of the present application is described by taking that a protocol stack and an application share a memory on a certain node in a multi-node computing system of an NUMA architecture when a network receives data packets and different processes or every parts of the same process share a memory on a certain node as examples, it should be understood by those skilled in the art that the method provided by the embodiments of the present application is not limited to the above application scenarios, and may be applicable to any scenario where a memory needs to be shared.

Referring to FIG. 2, which shows a structure schematic diagram of the apparatus for selecting a node where a shared memory is located in a multi-node computing system according to an embodiment of the present application. For the sake of easy description, those parts related to the embodiments of the present application are only shown. The functional modules/units contained in the apparatus illustrated in FIG. 2 may be software modules/units, hardware modules/units, or modules/units of combined software and hardware, and comprise a parameter acquiring module 201, a summing module 202 and a node selecting module 203.

The parameter acquiring module 201 is used to acquire the parameters for determining the sum of memory affinity weight values between each CPU and a memory on a random node, The parameters include the memory node pair weight values of the node pairs where each of the CPUs is located and the frequencies of accessing the memory on the random node by the each of the CPUs.

The summing module 202 is used to calculate the sum of the memory affinity weight values between each of the CPUs and a memory on a random node according to the parameters acquired by the summing module 202. The memory node pair weight value of the node pair is the memory affinity weight value between a CPU on one of the node pair and the memory on the other one of the node pair.

The node selecting module 203 is used to select the node with the minimal sum of the memory affinity weight values calculated by the summing module 202 as the node where a shared memory for each CPU is located.

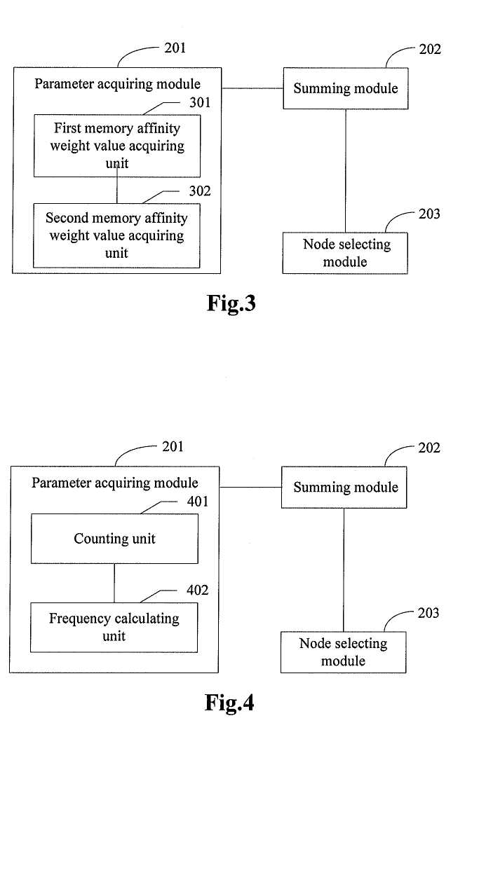

The parameter acquiring module 201 illustrated in FIG. 2 may further include a first memory affinity weight value acquiring unit 301 or a second memory affinity weight value acquiring unit 302 as illustrated in FIG. 3 which shows an apparatus for selecting a node where a shared memory is located in a multi-node computing system according to another embodiment of the present application.

The first memory affinity weight value acquiring unit 301 is configured to acquire the memory affinity weight value between a CPU on a node and a memory on a neighboring node of this node. The second memory affinity weight value acquiring unit 302 is configured to acquire the memory affinity weight value between a CPU on a node and a memory on a non-neighboring node of this node according to the memory affinity weight value between a CPU on a node and a memory on a neighboring node of this node acquired by the first memory affinity weight value acquiring unit 301.

As illustrated in FIG. 4, which shows an apparatus for selecting a node where a shared memory is located in a multi-node computing system according to another embodiment of the present application, the parameter acquiring module 201 further includes a counting unit 401 and a frequency calculating unit 402.

The counting unit 401 is configured to count the number of times of accessing the memory on the random node by a CPU on one node of each of the node pairs and the sum of these number of times.

The frequency computing unit 402 is configured to obtain a ratio of the number of times to the sum of the number of times according to the number of times and the sum of the number of times counted by the counting unit 401 and the ratio is the frequency of accessing the memory on the random node by each CPU.

The node selecting module 203 illustrated in FIG. 2 may further includes a product calculating unit 501 and a weight summing unit 502. As illustrated in FIG. 5, an apparatus for selecting a node where a shared memory is located in a multi-node computing system according to another embodiment of the present application is shown, wherein:

The product computing unit 501 is used to calculate the products of the memory node pair weighted values of the node pairs where the each of the CPUs is located and the frequencies of accessing the memory on the random node by the each of the CPUs.

The weight summing unit 502 is used to obtain the sum of the products calculated by the product computing unit 501. And the sum of the products is the sum of the memory affinity weight values between the each of the CPUs and the memory on a random node calculated according to the parameters.

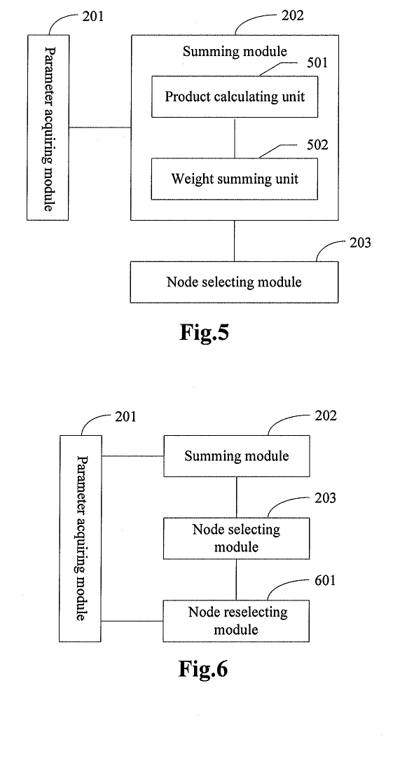

The apparatus illustrated in any one of FIGS. 2-5 may further include a node reselecting module 601, as illustrated in FIG. 6 which shows an apparatus for selecting a node where a shared memory is located in a multi-node computing system according to another embodiment of the present application. The node reselecting module 601 is used to check whether the memory on the node where a shared memory for each of the CPUs is located selected by the node selecting module 203 satisfies the access of each of the CPUs. If it does not satisfy, the parameter acquiring module 201, the summing module 202 and the node selecting module 203 are triggered to reselect the node where a shared memory is located.

It should be noted that in the implementations of the above apparatus for selecting a node where a shared memory is located in a multi-node computing system, the description of the distribution of every functional modules is exemplary only. In practice, the function distribution can be achieved by different functional modules as actually required, such as corresponding requirements on hardware configuration or software implementation. That is, the internal structure of the apparatus for selecting a node where a shared memory is located in a multi-node computing system is divided into different functional modules, so as to implement all or part of these functions. Furthermore, in practice, the corresponding functional modules of these embodiments may be either implemented by corresponding hardware, or by corresponding software executed by the hardware. For example, the above-described parameter acquiring unit may either be the hardware executing the function of acquiring parameters for determining the sum of memory affinity weight values between each of the CPUs accessing the shared memory and a memory on a random node, such as a parameter acquirer, or an ordinary processor or other hardware equipment capable of executing corresponding computer programs to implement the above-described functions. Another example, the above-described node selecting module may either be hardware executing the above-described functions, such as a node selector, or an ordinary processor or other hardware equipment capable of executing corresponding computer programs to implement the above-described functions.

It should be noted that since the information interaction, execution processes and the like of the modules/units of the above apparatus are based on the same concept as the method embodiments of the present application, and the technical effects are the same as those of the method embodiments, details thereof may be found in the description of the method embodiments of the present application, which are omitted for brief.

It should be understood by those skilled in the art that all or part of the steps in the methods of the above embodiments may be carried out by hardware instructed by programs, and the programs may be stored in a computer-readable medium which may include a read-only memory (ROM), random access memory (RAM), a floppy disc, or a compact disc, etc.

The method and apparatus for selecting a node where a shared memory is located in a multi-node computing system according to the embodiments of the present application are described above. The principle and embodiments of the present application are explained by particular examples, and the description of the above embodiments is merely for the purpose of assisting in understanding the method and core concepts of the present application. Meanwhile, alternations to the embodiments and the scope of application may be made by an ordinary person in the art according to the concept of the present application. In summary, the contents of the description of the present application should not be understood as limitations to the present application.

1. A method for selecting a node where a shared memory is located in a multi-node computing system, comprising:
acquiring parameters for determining a sum of memory affinity weight values between each of a plurality CPUs and a memory on a random one of nodes;
calculating the sum of the memory affinity weight values between each of the CPUs and the memory on the random one of the nodes according to the parameters; and
selecting a node with the calculated minimal sum of the memory affinity weight values as the node where a shared memory for each of the CPUs is located.

2. The method according to claim 1, wherein the parameters comprise a memory node pair weight value of a node pair where the each of the CPUs is located and frequencies of accessing the memory on the random one of the nodes by each of the CPUs.

3. The method according to claim 2, wherein the memory node pair weight value of the node pair is the memory affinity weight value between the CPU on one node of the node pair and the memory on the other node of the node pair.

4. The method according to claim 2, wherein acquiring the memory node pair weight value of the node pair where each of the CPUs is located comprises one of:
acquiring the memory affinity weight value between a CPU on a node and a memory on a neighboring node of the node; or
acquiring the memory affinity weight value between a CPU on a node and a memory on a non-neighboring node of the node, according to the acquired memory affinity weight value between the CPU on the node and a memory on a neighboring node of the node.

5. The method according to claim 2, wherein acquiring the frequencies of accessing the memory on the random node by the each of the CPUs comprises:
counting the number of times of accessing the memory on the random one of the nodes by the CPU on one node of each node pair and the sum of the number of times; and
obtaining a ratio of the number of times to the sum of the number of times according to the times and the sum of the times, wherein the ratio is the frequency of accessing the memory on the random one of the nodes by each of the CPUs.

6. The method according to claim 2, wherein calculating the sum of the memory affinity weight values between each of the CPUs and the memory on the random one of nodes according to the parameters comprises:
calculating the products of the memory node pair weight values of the node pairs where the each of the CPUs is located and the frequencies of accessing the memory on the random node by the each of the CPUs; and
obtaining a sum of the products, wherein the sum is a sum of the memory affinity weight values between the each of the CPUs and the memory on a random node calculated according to the parameters.

7. The method according to claim 1, wherein the method further comprises:
checking whether the memory on the node where the shared memory is located satisfies the access of the each of the CPUs, and if it does not satisfy, reselecting the node where the shared memory is located according to the method.

8. An apparatus for selecting a node where a shared memory is located in a multi-node computing system, comprising:
a parameter acquiring module, configured to acquire parameters for determining a sum of memory affinity weight values between each of a plurality of CPUs and a memory on a random one of nodes;
a summing module, configured to calculate the sum of the memory affinity weight values between each of the CPUs and the memory on the random one of the nodes according to the parameters; and
a node selecting module, configured to select a node with the calculated minimal sum of the memory affinity weight values as the node where a shared memory for each of the CPUs is located.

9. The apparatus according to claim 8, wherein the parameters comprise a memory node pair weight value of a node pair where the each of the CPUs is located, and frequencies of accessing the memory on the random one of the nodes by each of the CPUs.

10. The apparatus according to claim 9, wherein the memory node pair weight value of the node pair is the memory affinity weight value between a CPU on one node of the node pair and the memory on the other node of the node pair.

11. The apparatus according to claim 9, wherein the acquiring module comprises one of:
a first memory affinity weight value acquiring unit, configured to acquire a memory affinity weight value between a CPU on a node and a memory on a neighboring node of the node; or
a second memory affinity weight value acquiring unit, configured to acquire a memory affinity weight value between a CPU on a node and a memory on a non-neighboring node of the node, according to the memory affinity weight value between the CPU on the node and the memory on a neighboring node of the node acquired by the first memory affinity weight value acquiring unit.

12. The apparatus according to claim 9, wherein the acquiring module comprises:
a counting unit, for configured to count the number of times of accessing the memory on the random one of the nodes by the CPU on one node of each node pair and the sum of these number of times; and
a frequency calculating unit, configured to obtain a ratio of the number of times to the sum of the number of times according to the number of times and the sum of the number of times counted by the counting unit 401, wherein the ratio is the frequency of accessing the memory on the random one of the nodes by each of the CPUs.

13. The apparatus according to claim 9, wherein the summing module comprises:
a product calculating unit, configured to calculate products of the memory node pair weight values of the node pairs where the each of the CPUs is located and the frequencies of accessing the memory on the random one of the nodes by the each of the CPUs; and
a weight summing unit, configured to obtain the sum of the products calculated by the product computing unit 501, wherein the sum of the products is the sum of the memory affinity weight values between each of the CPUs and the memory on a random node calculated according to the parameters.

14. The apparatus according to claim 8, wherein the apparatus further comprises:
a node reselecting module, configured to check whether the memory on the node where the shared memory for each of the CPUs is located selected by the node selecting module satisfies the access of the each of the CPUs, and if it does not satisfy, triggering the parameter acquiring module, the summing module and the node selecting module to reselect the node where the shared memory for each of the CPUs is located.
